(19) United States
(12) Patent Application Publication
(10) Pub. No.: US 2022/0060018 A1
(43) Pub. Date: Feb. 24, 2022

(54) MICROGRID SYSTEM COMPRISING ENERGY MANAGEMENT SYSTEM OF ENERGY STORAGE SYSTEM (ESS)-CONNECTED PHOTOVOLTAIC POWER SYSTEM

(71) Applicant: Hanmi E&C Inc., Seoul (KR)

(72) Inventors: Sooyoung Jung, Seoul (KR); Yong Tae Yoon, Seoul (KR); Miran Jung, Seoul (KR); Jun Ho Huh, Busan (KR)

(21) Appl. No.: 17/084,873

(22) Filed: Oct. 30, 2020

(30) Foreign Application Priority Data
Aug. 21, 2020 (KR) 10-2020-0105205

(51) Int. Cl. H02J 3/00; G05F 1/67

(52) U.S. Cl. CPC H02J 3/004; H02J 2300/24; H02J 3/003; G05F 1/67

(57) ABSTRACT

An improved EMS (Energy Management System) of ESS (Energy Storage System)—connected photovoltaic power system is provided, where the economic efficiency of the microgrid power transaction is maximized by minimizing the amount paid to the power system as a result of optimal operation as to the energy supply and demand in the process of transacting power surplus/shortage with the power system, the responsiveness to passive resource energy forecasting of supply and demand is improved by resolving the uncertainty of solar power generation forecasting and load forecasting, the deterioration of the available storage capacity of ESS is minimized, and contribution to solving the nation's power supply shortage is made by the operation based on the detailed identification of energy storage status of ESS.

### CROSS-REFERENCE TO RELATED APPLICATION

This application claims priority to Korean Patent Application No. 10-2020-0105205, filed Aug. 21, 2020, the entire content of which is hereby incorporated by reference.

### BACKGROUND

### 1. Field of the Invention

The present invention relates to a microgrid system comprising an energy management system of an energy storage system-connected photovoltaic power system. More specifically, the present invention related to a microgrid system comprising an improved EMS (Energy Management System) of ESS (Energy Storage System)—connected photovoltaic power system wherein the economic efficiency of the microgrid power transaction is maximized by minimizing the amount paid to the power system as a result of optimal operation as to the energy supply and demand in the process of transacting power surplus/shortage with the power system, the responsiveness to passive resource energy forecasting of supply and demand is improved by resolving the uncertainty of solar power generation forecasting and load forecasting, the deterioration of the available storage capacity of ESS is minimized, and contribution to solving the nation's power supply shortage is made by the operation based on the detailed identification of energy storage status of ESS.

### 2. Description of Related Art

Efforts are being made in each country to prevent global warming along with the depletion of fossil fuels, and as a part of such efforts, technology development on eco-friendly energy is increasing. In addition, the rapidly increasing demand for electricity calls for a number of tasks regarding policy formulation and solutions to resolve the national electricity shortage. Accordingly, the need for energy-independent zero-energy community-based technology has emerged nationally, and the competition to preoccupy the market by various player including global companies is being heated in the field of microgrid with the objective of coping with global climate change and solving energy shortage problem.

However, domestically, the field of real-time energy sharing and trading based on microgrids remains at early stage in view of the worldwide technology development level, so concentrated efforts for faster technology development is necessary to occupy the market early. Early acquisition of technology is necessary to expand domestic technological capacity for world market in this field. It is necessary to develop technologies on automatic generation of operation schedule on microgrid distributed resources. And it should be noted that the parading is shifting from conventional manual control by the manager to software-based automatic control.

### SUMMARY OF THE INVENTION

The main objective of the present invention is to provide a microgrid system comprising an improved EMS (Energy Management System) of ESS (Energy Storage System)—connected photovoltaic power system to maximize the economic efficiency of the microgrid power transaction by minimizing the amount paid to the power system as a result of optimal operation as to the energy supply and demand in the process of transacting power surplus/shortage with the power system (grid), to improve the responsiveness to passive resource energy forecasting of supply and demand by resolving the uncertainty of solar power generation forecasting and load forecasting, to minimize the deterioration of the available storage capacity of ESS, and to make contribution to solving the nation's power supply shortage by the operation based on the detailed identification of energy storage status of ESS. Here passive energy means energy generated by distributed energy generation means such as PV (photovoltaic system), wind power system, fuel cell system, etc. And also, EG stands for energy generation.

To achieve the objective described above related to a microgrid system comprising an EMS (energy management system) ESS (Energy Storage System), the present invention provides a microgrid system comprising an EMS (energy management system) of ESS (Energy Storage System)—connected photovoltaic power system, the EMS comprising: a first module which forecasts power supply and demand, does operation scheduling, and controls ESS that stores a distributed energy generation system's electricity, or photovoltaic (PV) electricity, as an example; a second module for checking and managing state of charge of the ESS; a third module for calculating and managing the discharge rate of the ESS; a fourth module for system power leveling control to reduce a difference between maximum value and minimum value of system power by checking a load, photovoltaic power generation amount, charge/discharge rate of ESS, and system power usage by the microgrid; a fifth module for system power smoothing control reducing a variation in the usage of system power by time period; a sixth module for controlling power smoothing of the ESS; a seventh module for controlling the peak of power usage; an eighth module for controlling net zero energy operation so that power demand and supply are balanced; a ninth module for controlling a power demand response based on the amount of ESS discharge; and a control unit for controlling each module.

According to the present invention, beneficial effects such as maximizing the economic efficiency of the microgrid power transaction by minimizing the amount paid to the power system as a result of optimal operation as to the energy supply and demand in the process of transacting power surplus/shortage with the power system, improving the responsiveness to passive resource energy forecasting of supply and demand by resolving the uncertainty of solar power generation forecasting and load forecasting, minimizing the deterioration of the available storage capacity of ESS, and contribution to solving the nation's power supply shortage by the operation based on the detailed identification of energy storage status of ESS may be achieved.

According to an embodiment, the present invention provides a microgrid system comprising an energy generation (EG) system; one or more electrical load coupled to the EG system; an ESS (energy storage system) coupled to the EG system and the electrical load; an EMS (energy management system) for managing energy of the microgrid including the EG, the one or more electrical load, the ESS, and power transaction between the microgrid and a system power (grid);

wherein the EMS comprises: a first module which forecasts power supply and demand, does operation scheduling, and controls ESS that stores EG electricity; a second module for checking and managing state of charge of the ESS; a third module for calculating and managing the discharge rate of the ESS; a fourth module for system power flattening control to reduce a difference between maximum value and minimum value of system power by checking the load, the EG system generation amount, charge/discharge rate of the ESS, and the system power (grid) power usage by the microgrid; a fifth module for system power smoothing control reducing a variation in the usage of system power by time periods; a sixth module for controlling power smoothing of the ESS; a seventh module for controlling the peak of power usage; an eighth module for controlling net zero energy operation so that power demand and supply are balanced; a ninth module for controlling a power demand response based on the amount of ESS discharge; and a control unit for controlling each module, wherein controlling operations of the modules are conducted so as to minimize the amount paid to the grid.

According to another embodiment, the present invention provides a system wherein the controlling operations of the modules are further conducted to reflect a difference between a maximum system power (grid) usage and a minimum system power (grid).

According to still another embodiment, the present invention provides a system wherein the controlling operations of the modules are further conducted to reflect the peak power usage.

According to another embodiment, the present invention provides a system wherein the controlling operation of the modules are further conducted to reflect power smoothing of the ESS.

According to another embodiment, the present invention provides a system wherein the controlling operation of the modules are further conducted to reflect the net zero energy operation.

According to still another embodiment, the present invention provides a system wherein the controlling operation of the modules are further conducted to reflect the power demand response based on the amount of ESS discharge.

### BRIEF DESCRIPTION OF THE DRAWINGS

FIG. 1 shows a system diagram of a microgrid system according to certain embodiment.

FIG. 2 is an example that shows how system power usage and ESS charging/discharging power change depending on the external conditions (peak control, net zero operation, flattening and demand response, etc.) applied.

FIGS. 3-5 are exemplary views showing examples wherein information to be forecasted and monitored by an EMS of ESS-connected photovoltaic power system.

### DESCRIPTION OF EXEMPLARY EMBODIMENTS

Hereinafter, preferred embodiments according to the present invention will be described in more detail with reference to the accompanying drawings. The present invention is related to a microgrid (MG) 400 which comprises an energy storage system (ESS) 410, and an energy management system (EMS) 100. First, a microgrid (MG) is a system composed of distributed power sources or MG's, various power loads, and measuring instruments, and is operated independently or in connection with the power grid of a power company, and is classified as shown in Table 1.

TABLE 1

| Classification | | Application | Characteristic |
|---|---|---|---|
| Linked type | MG for | Customer-owned | Electricity transaction + self-generation → electricity |
| MG | customers | facilities | rate↓, reliability↑ |
| | | | Always connected operation with distribution system |
| | | | Uninterrupted supply by switching to single operation in |
| | | | case of emergency |
| | | | Composed of one or more MGs in campus, hospital, |
| | | | building, military base, etc. Example) Smart E-Campus |
| | MG for | Power company | Power line operation efficiency + self-generation → |
| | distribution | (By D/L section) | purchase cost↓, reliability↑ |
| | | | Renewable E+ battery connection, operating all or part |
| | | | of the distribution system as MG → Power line operation |
| | | | efficiency, increasing new and renewable energy e.g.) |
| | | | Linked MG (Shinan), Canadian distribution-class MG |
| | | | project |
| Standalone | Energy | Small and | Self-generation + MG EMS → fuel cost↓, |
| MG | Independent | Medium Sized | quality/reliability↑ |
| | MG | Islands | Inverter controls voltage/frequency: improves power |
| | | (Electricity | quality |
| | | Projects) | High new and renewable energy introduction rate (50% |
| | | | or more) Ex) Kasa Island energy independence island |
| | Hybrid | Large Sized | Self-generation + MG EMS → fuel cost↓, |
| | MG | Islands, Remote | quality/reliability↑ |
| | | Areas (Electricity | Diesel generator controls voltage/frequency |
| | | Projects) | Diesel generator + renewable energy (less than 50%) |
| | | | Ex) Geochado, Ulleungdo, Deokjeokdo, etc. |

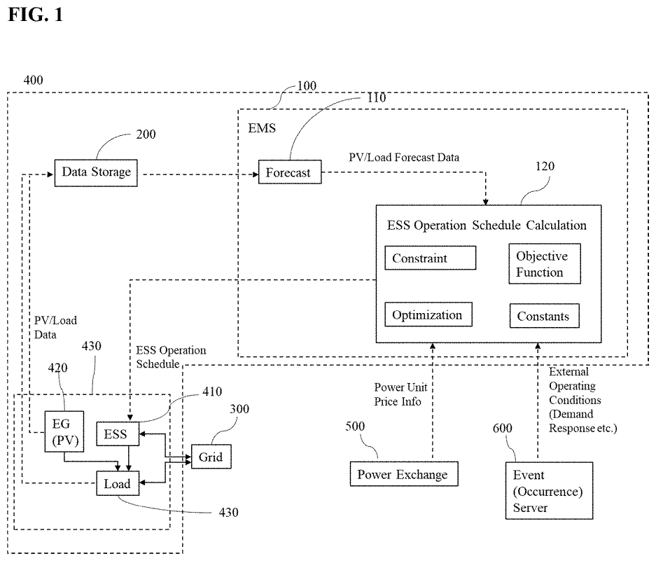

FIG. 1 shows a system diagram of a microgrid system according to certain embodiment. Here, solid line arrows indicate the supply of power, and dotted line arrows the flow of information. Although both energy management system (EMS) 100 and data storage 200 belong to the Microgrid 400, the Microgrid Sub-system 430, in this case, is one that consists of new and renewable energy sources or EG sources, loads and energy storage system (ESS) 410. There are a number of new and renewable energy sources such as photovoltaic (PV) and wind turbine (WT) but only PV 420 was indicated for convenience. The power produced by PV will be stored in the ESS or consumed by the load. Also, PV/Load data are used to predict the future PV/load value after being stored in data storage. The Power Grid (Grid 300) supply electricity to the ESS 410 or load 430, whereas the unit cost of power is provided at the power exchange 500. The event server 600 assumes the role of notifying the situation wherein DR (Demand Response) or net zero operation is required. There will be no information about the external operating conditions from the event server in a scenario that does not include any special conditions; otherwise, the constraints and objective function will be changed after receiving external operating condition information. And the conditions may include peak control, power use flattening, power demand response and operation of net zero energy, etc.

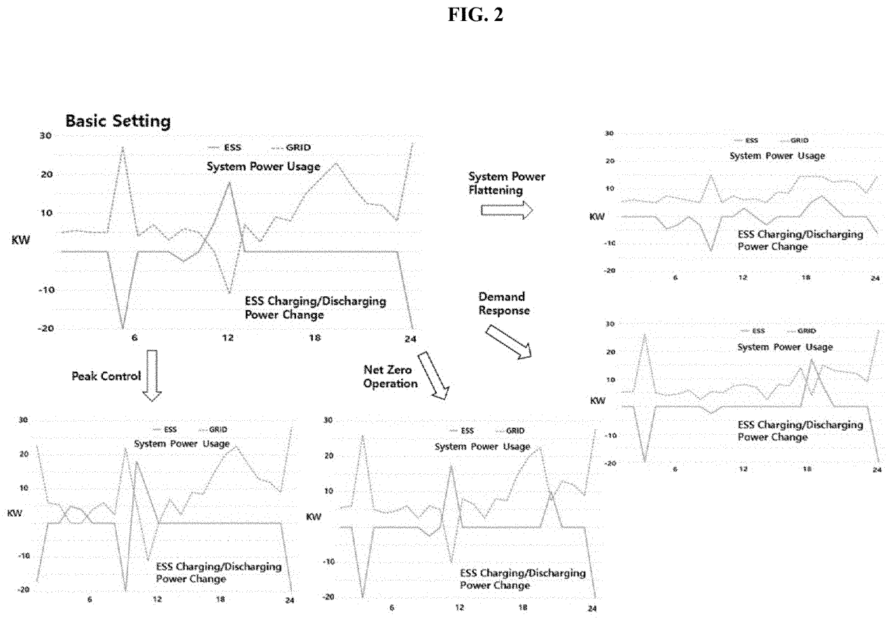

FIG. 2 is a diagram that shows, as an example, how system power usage and ESS 410 charging/discharging power change depending on the external conditions applied. The picture on the upper left is a basic setting and the rest of the pictures in order of bottom left, bottom center, upper left and bottom right show the change when peak control, net zero operation, flattening and demand response have been applied, respectively.

An ESS 410 is a device for improving efficiency in terms of energy use or cost reduction by storing electricity when it is produced by renewable energy generation (solar power generation) or when the power cost in the system is low and supplying it when necessary.

An EMS 100 refers to a system that can monitor, analyze and control remotely and in real time by linking sensors, measurement equipment, and analysis S/W. An EMS like this has four main functions: energy monitoring, energy management, analysis and statistics, and energy control. Energy monitoring is to monitor energy usage and real-time loads, and energy management does various management function including such as energy operation policy, energy operation efficiency targeting, overload reserve, and operation improvement. In the analysis and statistics function, reports submitted by the government and management of reduction projects are analyzed, and finally, in energy control, peak management (load remote control) and EMS operation data are controlled. In other words, EMS collects and analyzes energy-related data (data provided by a demand manager or public information/utility). Then, based on the analyzed data, an energy operation schedule in consideration of a saving method, etc. is derived and transmitted to the control side, and control management is performed based on the derived schedule.

The present invention achieves utilizes these functions and achieves objectives such as maximizing the economic efficiency of the microgrid power transaction by minimizing the amount paid to the power system as a result of optimal operation as to the energy supply and demand in the process of transacting power surplus/shortage with the power system, improving the responsiveness to passive resource energy forecasting of supply and demand by resolving the uncertainty of solar power generation forecasting and load forecasting, minimizing the deterioration of the available storage capacity of ESS 410, and contribution to solving the nation's power supply shortage by the operation based on the detailed identification of energy storage status of ESS, thereby providing improved EMS 100 of ESS-connected photovoltaic power system. To this end, the present invention provides an energy management system equipped with an algorithm capable of optimizing the microgrid energy demand and supply, and also with visualization thereof.

The EMS 100 according to the present invention comprises: a first module which forecasts power supply and demand, does operation scheduling, and controls ESS that stores photovoltaic (PV) electricity; a second module for checking and managing state of charge of the ESS; a third module for calculating and managing the discharge rate of the ESS; a fourth module for system power leveling control to reduce a difference between maximum value and minimum value of system power by checking a load, photovoltaic power generation amount, charge/discharge rate of ESS, and system power usage by the microgrid; a fifth module for system power smoothing control reducing a variation in the usage of system power by time slots; a sixth module for controlling power smoothing of the ESS; a seventh module for controlling the peak of power usage; an eighth module for controlling net zero energy operation so that power demand and supply are balanced; a ninth module for controlling a power demand response based on the amount of ESS discharge; and a control unit for controlling each module. Here, each module is an element having an operation processing function, and can be calculated and processed in the following manner.

### [First Module]

1) The following equation was used to express the maximum value of p^{d}^{_{b}}(i) which varies according to the situation. p^{d}^{_{b}}(i) is the discharge rate of ESS in the i-th time period, which can offset the amount purchased from the grid. p̅_{d,min}(i)=p̅_{d}(i)−Δp̅_{d}(i) is the minimum (expected) value of total demand, Δp̅_{d}(i) is the expected error of the total demand, p_{ESS}^{dis,max}(i) is the maximum discharge rate of the ESS in the i-th time period.

Pₘₐₓ^{d}^{_{b}}(i)=min(max(0,p̅_{d,min}(i)),p_{ESS}^{dis,max}(i))

2) The following equation was used to express the maximum value of p^{c}^{ₛ}(i) which varies according to the situation. p^{c}^{ₛ}(i) is the charging rate of ESS in the i-th time period, which can offset the amount sold to the grid. p̅_{d,max}(i)=p̅_{d}(i)+Δp̅_{d}(i) is the maximum (expected) value of total demand, p_{ESS}^{chg,max}(i) is the maximum charging rate of the ESS in the i-th time period.

Pₘₐₓ^{c}^{ₛ}(i)=min(max(0,−p̅_{d,max}(i)),p_{ESS}^{chg,max}(i))

3) The following equation was used to express the maximum value of p^{d}^{ᵤ}(i) which varies according to the situation. p^{d}^{ᵤ}(i) is the discharge rate of ESS in the i-th time period, which is the amount to cope with uncertainty.

Pₘₐₓ^{d}^{ᵤ}(i)=min(max(0,p̅_{d,max}(i))−max(0,p̅_{d,min}(i)),p̅_{ESS}^{dis,max}(i))

4) The following equation was used to express the maximum value of p^{c}^{ᵤ}(i) which varies according to the situation. p^{c}^{ᵤ}(i) is the charging rate of ESS in the i-th time period, which is the amount to cope with uncertainty.

Pₘₐₓ^{c}^{ᵤ}(i)=min(min(0,p̅_{d,max}(i))−min(0,p̅_{d,min}(i)),p_{ESS}^{chg,max}(i))

5) The following expression is used to express the range of p^{d}^{_{b}}(i) that varies according to the situation.

Pₘₐₓ^{d}^{_{b}}(i)(1−δ_{bs2}(i))≤p^{d}^{_{b}}(i)≤pₘₐₓ^{d}^{_{b}}(i)
i) 0≤p^{d}^{_{b}}(i)≤Pₘₐₓ^{d}^{_{b}}(i) if δ_{bs2}(i)=1
ii) p^{d}^{_{b}}(i)=Pₘₐₓ^{d}^{_{b}}(i) if δ_{bs2}(i)=0

0≤δ_{bs1}(i)≤1, 0≤δ_{bs2}(i)≤1

This condition is that δ_{bs1}(i), δ_{bs2}(i) each has a value between 0 and 1, and it is a condition that each has a value of 0 or 1 because each of the variable is integer. δ_{bs1}(i) is a binary variable indicating whether there is purchase of power form the grid, and δ_{bs2}(i) a binary variable indicating whether there is a sales of power to the grid. (1: yes, 0: no).

6) The following expression is used to express the range of p^{d}^{ₛ}(i) that varies according to the situation. p^{d}^{ₛ}(i) is the discharge rate of ESS in the i-th time period, which is the amount sold to the grid.

p^{d}^{ₛ}(i)≤p_{ESS}^{dis,max}(i)(1−δ_{bs2}(i))
i) p^{d}^{ₛ}(i)≤0 if δ_{bs2}(i)=1
ii) p^{d}^{ₛ}(i)≤p_{ESS}^{dis,max}(i) if δ_{bs2}(i)=0

7) The following expression is used to express the range of p^{c}^{ₛ}(i) which varies according to the situation.

Pₘₐₓ^{c}^{ₛ}(i)δ_{bs1}(i)≤p^{c}^{ₛ}(i)≤Pₘₐₓ^{c}^{ₛ}(i)
i) p^{c}^{ₛ}(i)=Pₘₐₓ^{c}^{ₛ}(i) if δ_{bs1}(i)=1
ii) 0≤p^{c}^{ₛ}(i)≤Pₘₐₓ^{c}^{ₛ}(i) if δ_{bs1}(i)=0

8) The following expression is used to express the range of p^{c}^{_{b}}(i) that varies according to the situation. p^{c}^{_{b}}(i) is the charging rate of ESS in the i-th time period, which is the amount purchased from the grid.

p^{c}^{_{b}}(i)≤p_{ESS}^{chg,max}(i)δ_{bs1}(i)
i) p^{c}^{_{b}}(i)≤p_{ESS}^{chg,max}(i) if δ_{bs1}(i)=1
ii) p^{c}^{_{b}}(i)≤0 if δ_{bs1}(i)=0

9) The following expression is used to express the range of p^{d}^{_{b}}(i) that varies according to the situation.

pₘₐₓ^{d}^{_{b}}(i)(1−δ_{bs1}(i))≤p^{d}^{_{b}}(i)
i) 0≤p^{d}^{_{b}}(i) if (δ_{bs1}(i),δ_{bs2}(i))=(1,1), (δ_{bs1}(i),δ_{bs2}(i))=(1,0)
ii) Pₘₐₓ^{d}^{_{b}}(i)≤p^{d}^{_{b}}(i) if (δ_{bs1}(i),δ_{bs2}(i))=(0,1), (δ_{bs1}(i),δ_{bs2}(i))=(0,0)

10) The following expression is used to express the range of p^{d}^{_{b}}(i) that varies according to the situation.

Pₘₐₓ^{d}^{ᵤ}(i)(1−δ_{bs2}(i))≤p^{d}^{ᵤ}(i)≤Pₘₐₓ^{d}^{ᵤ}(i)(1−δ_{bs1}(i))
i) p^{d}^{ᵤ}(i)=0 if (δ_{bs1}(i),δ_{bs2}(i))
ii) Pₘₐₓ^{d}^{ᵤ}(i)≤p^{d}^{ᵤ}(i)≤0 if (δ_{bs1}(i),δ_{bs2}(i))=(1,0)
iii) 0≤p^{d}^{ᵤ}(i)≤Pₘₐₓ^{d}^{ᵤ}(i) if (δ_{bs1}(i),δ_{bs2}(i))=(0,1)
iv) p^{d}^{ᵤ}(i)=Pₘₐₓ^{d}^{ᵤ}(i) if (δ_{bs1}(i),δ_{bs2}(i))=(0,0)

11) The following expression is used to express the range of p^{c}^{ₛ}(i) that varies according to the situation.

Pₘₐₓ^{c}^{ₛ}(i)δ_{bs2}(i)≤p^{c}^{ₛ}(i)
i) Pₘₐₓ^{c}^{ₛ}(i)≤p^{c}^{ₛ}(i) if (δ_{bs1}(i),δ_{bs2}(i))=(1,1)
ii) 0≤p^{c}^{ₛ}(i) if (δ_{bs1}(i),δ_{bs2}(i))=(1,0)
iii) Pₘₐₓ^{c}^{ₛ}(i)≤p^{c}^{ₛ}(i) if (δ_{bs1}(i),δ_{bs2}(i))=(0,1)
iv) 0≤p^{c}^{ₛ}(i) if (δ_{bs1}(i),δ_{bs2}(i))=(0,0)

12) The following expression is used to express the range of p^{c}^{ᵤ}(i) that varies according to the situation.

Pₘₐₓ^{c}^{ᵤ}(i)δ_{bs1}(i)≤p^{c}^{ᵤ}(i)≤Pₘₐₓ^{c}^{ᵤ}(i)δ_{bs2}(i)
i) p^{c}^{ᵤ}(i)=Pₘₐₓ^{c}^{ᵤ}(i) if (δ_{bs1}(i),δ_{bs2}(i))=(1,1)
ii) Pₘₐₓ^{c}^{ᵤ}(i)≤p^{c}^{ᵤ}(i)≤0 if (δ_{bs1}(i),δ_{bs2}(i))=(1,0)
iii) 0≤p^{c}^{ᵤ}(i)≤Pₘₐₓ^{c}^{ᵤ}(i) if (δ_{bs1}(i),δ_{bs2}(i))=(0,1)
iv) p^{c}^{ᵤ}(i)=0 if (δ_{bs1}(i),δ_{bs2}(i))=(0,0)

13) The following expression is used to reflect the range of p^{d}^{ᵤ}(i) in the objective function. w_{d}(i) is a variable introduced to cope with the uncertainty in the i-th time period, and z_{d} is a variable introduced to cope with to the uncertainty bearing no physical meaning. c_{buy}(i) is the price of purchasing a unit amount of electricity from the grid in the i-th time period, cₛₑₗₗ(i) is the price at which the unit amount of electricity is sold to the grid in the i-th time period, and dt is the unit time.

$$0.5 \vert {c}_{b u y} ( i ) - {c}_{s e l l} ( i ) \vert {p}^{{d}_{u}} ( i ) d t \leq {z}_{d} + {w}_{d} ( i ) \\ i ) 0 \leq {z}_{d} + {w}_{d} ( i ) if \vert {c}_{b u y} ( i ) - {c}_{s e l l} ( i ) \vert = 0 \\ ii ) {p}^{{d}_{u}} ( i ) \leq \frac{{z}_{d} + {w}_{d} ( i )}{0.5 \vert {c}_{b u y} ( i ) - {c}_{s e l l} ( i ) \vert dt} if \vert {c}_{b u y} ( i ) - {c}_{s e l l} ( i ) \vert \neq 0$$

14) The following expression is used to reflect the range of p^{c}^{ᵤ}(i) in the objective function. w_{c}(i) is a variable introduced to cope with the uncertainty in the i-th time period, and z_{c} is a variable introduced to cope with to the uncertainty bearing no physical meaning.

$$0.5` \vert {c}_{b u y} ( i ) - {c}_{s e l l} ( i ) \vert {p}^{{c}_{u}} ( i ) d t \leq {z}_{c} + {w}_{c} ( i ) \\ i ) 0 \leq {z}_{c} + {w}_{c} ( i ) if \vert {c}_{b u y} ( i ) - {c}_{s e l l} ( i ) \vert = 0 \\ ii ) {p}^{{c}_{u}} ( i ) \leq \frac{{z}_{c} + {w}_{c} ( i )}{0.5 \vert {c}_{b u y} ( i ) - {c}_{s e l l} ( i ) \vert dt} if \vert {c}_{b u y} ( i ) - {c}_{s e l l} ( i ) \vert \neq 0$$

15) Set the objective function as J, and set it so that J tends to decrease according as the situation fits the purpose.

J≤t

It is a condition that J has a value oft or less. Under this condition, The objective is to find a controlling status which minimizes J. J is minimized by minimizing t, where t is a variable needed to derive an operation schedule to cope with uncertainty.

$$J = \sum ( \begin{matrix}[ {c}_{buy} ( i ) \{ {p}^{{c}_{b}} ( i ) - {p}^{{d}_{b}} ( i ) \} - {c}_{sell} ( i ) \{ {p}^{{d}_{s}} ( i ) - {p}^{{c}_{s}} ( i ) \} + \\ 0.5 \{ {c}_{sell} ( i ) + {c}_{buy} ( i ) \} \{ {p}^{{c}_{u}} ( i ) - {p}^{{d}_{u}} ( i ) \} ] dt + {w}_{c} ( i ) + {w}_{d} ( i ) )\end{matrix} ) + Γ {z}_{c} + Γ {z}_{d}$$

When the customer charges the storage device, the value of J increases, and when the storage device is discharged, the value of J decreases. The underlined part is to cope with the uncertainty, and the rest that is not underlined is: (electricity cost)−(saving/additional gain).

0≤δ_{bs1}(i)≤1, 0≤δ_{bs2}(i)≤1

This condition is that δ_{bs1}(i), δ_{bs2}(i) each has a value between 0 and 1, and it is a condition that each has a value of 0 or 1 because each of the variable is integer. δ_{bs1}(i) is a binary variable indicating whether there is purchase of power form the grid, and δ_{bs2}(i) a binary variable indicating whether there is a sales of power to the grid. (1: yes, 0: no).

z_{d}≥0, z_{c}≥0, w_{d}(i)≥0, w_{c}(i)≥0

This condition means that each of the variables z_{d}, z_{c}, w_{d}(i), w_{c}(i) has a value greater than or equal to zero.

### [Second Module]

1) When δ_{dis}(i) and δ_{chg}(i) are added, the condition that it has a value of 0 or more is expressed by the following expression. δ_{dis}(i) is a binary variable indicating whether the energy storage device is discharged in the i-th time period, and δ_{chg}(i) is a binary variable indicating whether the energy storage device is charged in the i-th time period.

−δ_{dis}(i)−δ_{chg}(i)≤0 (δ_{dis}(i)+δ_{chg}(i)≥0)

2) When δ_{dis}(i) and δ_{chg}(i) are added, the condition that it has a value of 1 or less is expressed by the following expression.

δ_{dis}(i)+δ_{chg}(i)≤1

3) The minimum value of the ESS discharge rate is expressed using the following expression. (p^{d}^{_{b}}(i)+p^{d}^{ₛ}(i)+p^{d}^{ᵤ}(i)) is the discharge rate of the ESS.

P_{ESS}^{dis,min}(i)·δ_{dis}(i)≤p^{d}^{_{b}}(i)+p^{d}^{ₛ}(i)+p^{d}^{ᵤ}(i)

4) The maximum value of the ESS discharge rate is expressed using the following expression. P_{ESS}^{dis,max}(i) is the maximum value of the ESS discharge rate in the i-th time period.

p^{d}^{_{b}}(i)+p^{d}^{ₛ}(i)+p^{d}^{ᵤ}(i)≤P_{ESS}^{dis,max}(i)·δ_{dis}(i)

5) The minimum value of the Ess charge rate is expressed using the following expression. (p^{c}^{ₛ}(i)+p^{c}^{_{b}}(i)+p^{c}^{ᵤ}(i)) is the charging rate of the ESS.

p_{ESS}^{chg,min}(i)·δ_{chg}(i)≤p^{c}^{ₛ}(i)+p^{c}^{_{b}}(i)+p^{c}^{ᵤ}(i)

6) The maximum value of the Ess charge rate is expressed using the following expression. p_{ESS}^{chg,max}(i) is the maximum value of the Ess charge rate in the i-th time period.

p^{c}^{ₛ}(i)+p^{c}^{_{b}}(i)+p^{c}^{ᵤ}(i)≤p_{ESS}^{chg,max}(i)·δ_{chg}(i)

7) 0≤δ_{dis}(i)≤1, 0≤δ_{chg}(i)≤1

It is the condition that each of δ_{dis}(i) and δ_{chg}(i) has values between 0 and 1. Since each of the variables is integer variables, as a result, each will have a value of 0 or 1.

8) p^{d}^{_{b}}(i)≥0, p^{d}^{ₛ}(i)≥0, p^{d}^{ᵤ}(i)≥0, p^{c}^{ₛ}(i)≥0, p^{c}^{_{b}}(i)≥0, p^{c}^{ᵤ}(i)≥0

It is a condition that each of the variables p^{d}^{_{b}}(i), p^{d}^{ₛ}(i), p^{d}^{ᵤ}(i), p^{c}^{ₛ}(i), p^{c}^{_{b}}(i), p^{c}^{ᵤ}(i) has a value greater than or equal to zero.

### [Third Module]

1) The sum of the SOC increased by charging from the first time period to the i-th time period can be expressed by the following expression. η_{chg} is the charging efficiency of the ESS, and E_{cap} is the capacity of the ESS.

$${\sum }_{k = 1}^{i} \frac{{η}_{c h g} d t}{{E}_{c a p}} ( {p}^{{c}_{s}} ( k ) + {p}^{{c}_{b}} ( k ) + {p}^{{c}_{u}} ( k ) )$$

The sum of SOC reduced by discharge from the first time period to the i-th time period can be expressed by the following expression. η_{dis} is the discharge efficiency of the ESS.

$$- {{\sum }_{k = 1}}^{i} \frac{d t}{{η}_{dis} {E}_{c a p}} ( {p}^{{d}_{b}} ( k ) + {p}^{{d}_{s}} ( k ) + {p}^{{d}_{u}} ( k ) )$$

The sum of the SOC reduced by natural discharge from the first time period to the i-th time period can be expressed by the following equation. P_{ESS}^{self}(i) is the natural discharge rate of the ESS.

$$- {{\sum }_{k = 1}}^{i} \frac{d t}{{E}_{c a p}} {p}_{E S S}^{s e l f} ( k )$$

Using these, the condition that the state of charge determined by charging and discharging up to the i-th time period is greater than or equal to the minimum value of the state of charge in the i+1 th time period can be expressed by the following expression. SOC(i) is the state of charge in the i-th time period, and SOCₘᵢₙ(i) is the minimum value of the state of charge in the i-th time period.

$${SOC}_{min} ( i + 1 ) \leq SOC ( 1 ) + {\sum }_{k = 1}^{i} \frac{{η}_{c h g} d t}{{E}_{cap}} ( {p}^{{c}_{s}} ( k ) + {p}^{{c}_{b}} ( k ) + {p}^{{c}_{u}} ( k ) ) - {{\sum }_{k = 1}}^{i} \frac{d t}{{η}_{dis} {E}_{cap}} ( {p}^{{d}_{b}} ( k ) + {p}^{{d}_{s}} ( k ) + {p}^{{d}_{u}} ( k ) ) - {{\sum }_{k = 1}}^{i} \frac{d t}{{E}_{cap}} {p}_{E S S}^{self} ( k )$$

2) The sum of the SOC increased by charging from the first time period to the i-th time period can be expressed by the following expression.

$${\sum }_{k = 1}^{i} \frac{{η}_{c h g} d t}{{E}_{c a p}} ( {p}^{{c}_{s}} ( k ) + {p}^{{c}_{b}} ( k ) + {p}^{{c}_{u}} ( k ) )$$

The sum of SOC reduced by discharge from the first time period to the i-th time period can be expressed by the following expression.

$$- {{\sum }_{k = 1}}^{i} \frac{d t}{{η}_{dis} {E}_{c a p}} ( {p}^{{d}_{b}} ( k ) + {p}^{{d}_{s}} ( k ) + {p}^{{d}_{u}} ( k ) )$$

The sum of SOC reduced by natural discharge from the first time period to the i-th time period can be expressed by the following expression.

$$- {{\sum }_{k = 1}}^{i} \frac{d t}{{E}_{c a p}} {p}_{E S S}^{self} ( k )$$

Therefore, the condition that the state of charge determined by charging and discharging up to the i-th time period is less than or equal to the maximum value of the state of charge in the i+l-th time period can be expressed by the following expression. SOCₘₐₓ(i) is the maximum value of the state of charge in the i-th time period.

$$SOC ( 1 ) + {{\sum }_{k = 1}}^{i} \frac{{η}_{c h g} d t}{{E}_{cap}} ( {p}^{{c}_{s}} ( k ) + {p}^{{c}_{b}} ( k ) + {p}^{{c}_{u}} ( k ) ) - {{\sum }_{k = 1}}^{i} \frac{d t}{{η}_{dis} {E}_{cap}} ( {p}^{{d}_{b}} ( k ) + {p}^{{d}_{s}} ( k ) + {p}^{{d}_{u}} ( k ) ) - {{\sum }_{k = 1}}^{i} \frac{d t}{{E}_{cap}} {p}_{E S S}^{self} ( k ) \leq {SOC}_{max} ( i + 1 )$$

### [Fourth Module]

1) The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand
   Therefore, NetDemand−ESS=Grid. Here, for NetDemandMin which is the minimum value of the total demand, the following expression is used which is equivalent to p_{g}^{min}≤NetDemandMin−ESS.

p_{g}^{min}≤p̅_{d,min}(i)+p^{c}^{_{b}}(i)+p^{c}^{ᵤ}(i)+p^{c}^{ₛ}(i)−p^{d}^{_{b}}(i)−p^{d}^{ᵤ}(i)−p^{d}^{ₛ}(i)

2) The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand
   Therefore, NetDemand−ESS=Grid. Here, for NetDemandMax which is the maximum value of the total demand, the following expression is used which is equivalent to NetDemandMax−ESS≤p_{g}^{max}.

p̅_{d,max}(i)+p^{c}^{_{b}}(i)+p^{c}^{ᵤ}(i)+p^{c}^{ₛ}(i)−p^{d}^{_{b}}(i)−p^{d}^{ᵤ}(i)−p^{d}^{ₛ}(i)≤p_{g}^{max}
3) c_{g}^{flat}(p_{g}^{max}−p_{g}^{min})T
   By adding this equation to J, the difference between the maximum grid power value and the minimum grid power value (p_{g}^{max}−p_{g}^{min}) is reflected in the objective function. To reduce the value of J, the value of is (p_{g}^{max}−p_{g}^{min}) reduced, so the use of system power is flattened. If the value of the penalty constant c_{g}^{flat} for flattening of grid power is larger, the effect of flattening is reflected more. T is the control period.

### [Fifth Module]

1)

p_{g}^{dev}(i)≤[p̅_{d,min}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)]−[p̅_{d,max}(i−1)−p^{d}^{_{b}}(i−1)−p^{d}^{ᵤ}(i−1)−p^{c}^{_{b}}(i−1)+p^{c}^{_{b}}(i−1)+p^{c}^{ᵤ}(i−1)+p^{c}^{ₛ}(i−1)],

If i=1,

−p_{g}^{dev}(i)≤[p̅_{d,min}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)]−[p_{g}^{buy,prev}−p_{g}^{sell,prev}]

The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand

Therefore, NetDemand−ESS=Grid.

Utilizing this, [p̅_{d,min}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)] is the minimum value of the grid power consumption in the i-th time period. Also, [p̅_{d,max}(i−1)−p^{d}^{_{b}}(i−1)−p^{d}^{ᵤ}(i−1)−p^{d}^{ₛ}(i−1)+p^{c}^{_{b}}(i−1)+p^{c}^{ᵤ}(i−1)+p^{c}^{ₛ}(i−1)] is the maximum value of the grid power usage in the i−1th time period. Therefore, the given expression is a condition that (minimum value of grid power consumption in the i-th time period)−(maximum value of grid power consumption in the i−1 th time period) has a value greater than or equal to −p_{g}^{dev}(i). When i=1, use [p_{g}^{buy,prev}−p_{g}^{sell,prev}] instead of (maximum value of grid power consumption in the i−1 th time period).

2)

[p̅_{d,max}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)]−[p̅_{d,min}(i−1)−p^{d}^{_{b}}(i−1)−p^{d}^{ᵤ}(i−1)−p^{d}^{ₛ}(i−1)+p^{c}^{_{b}}(i−1)+p^{c}^{ᵤ}(i−1)+p^{c}^{ₛ}(i−1)]≤p_{g}^{dev}(i),

if i=1,

[p̅_{d,max}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)]−[p_{g}^{buy,prev}−p_{g}^{sell,prev}]≤p_{g}^{dev}(i)

The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand

Therefore, NetDemand−ESS=Grid.

Utilizing this, [p̅_{d,max}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)] is the maximum value of the grid power consumption in the i-th time period. Also, [p̅_{d,min}(i−1)−p^{d}^{_{b}}(i−1)−p^{d}^{ᵤ}(i−1)−p^{d}^{ₛ}(i−1)+p^{c}^{_{b}}(i−1)+p^{c}^{ᵤ}(i−1)+p^{c}^{ₛ}(i−1)] is the minimum value of the grid power usage in the i−1th time period. Therefore, the given expression is a condition that (maximum value of grid power consumption in the i-th time period)−(minimum value of grid power consumption in the i−1 th time period) has a value less than or equal to p_{g}^{dev}(i). When i=1, use [p_{g}^{buy,prev}−p_{g}^{sell,prev}] instead of (minimum value of grid power consumption in the i−1 th time period).

3) 0≤p_{g}^{dev}(i)

It is a condition that p_{g}^{dev}(i) is greater than or equal to zero.

$$4 ) {{\sum }_{i = 1}}^{N} {c}_{s m , g} \cdot dt \cdot {p}_{g}^{dev} ( i ) \qquad$$

If this expression is added to J, p_{g}^{dev}(i) which is a variable for smoothing the power consumption is reflected in the objective function. To reduce the value of J, the value of p_{g}^{dev}(i) is reduced, so that the difference of power consumption from the previous time period is reduced for each time period, thereby grid power smoothing is performed. If the value of c_{sm,g} is larger, the smoothing effect is reflected more.

### [Sixth Module]

1)

−P_{ESS}^{dev}(i)≤[p^{d}^{_{b}}(i)+p^{d}^{_{b}}(i)+p^{d}^{ₛ}(i)−p^{c}^{_{b}}(i)−p^{c}^{_{b}}(i)−p^{c}^{ₛ}(i)]−[p^{d}^{_{b}}(i−1)+p^{d}^{ᵤ}(i−1)+p^{d}^{ₛ}(i−1)−p^{c}^{_{b}}(i−1)−p^{c}^{ᵤ}(i−1)−p^{cis s}(i−1)]

if i=1,

−p_{ESS}^{dev}(i)≤[p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)]−[p_{ESS}^{dis,prev}−p_{ESS}^{chg,prev}]

Here, [p^{d}^{_{b}}(i)+p^{dis u}(i)+p^{dis s}(i)−p^{c}^{_{b}}(i)−p^{c}^{ᵤ}(i)−p^{c}^{ₛ}(i)] is ESS charge/discharge rate in the i-th time period. Also, [p^{d}^{_{b}}(i−1)+p^{d}^{ᵤ}(i−1)+p^{d}^{ₛ}(i−1)−p^{c}^{_{b}}(i−1)−p^{c}^{ᵤ}(i−1)−p^{c}^{ₛ}(i−1)] is the ESS charge/discharge rate in the i−1th time period. Therefore, the given expression is a condition that (ESS charge/discharge rate in the i-th time period)−(ESS charge/discharge rate in the i−1th time period) has a value greater than or equal to −p_{ESS}^{dev}(i). When i=1, use [p_{ESS}^{dis,prev}−p_{ESS}^{chg,prev}] instead of (ESS charge/discharge rate in the i−1 time period).

2)

[p^{d}^{_{b}}(i)+p^{d}^{ᵤ}(i)+p^{d}^{ₛ}(i)−p^{c}^{_{b}}(i)−p^{c}^{ᵤ}(i)−p^{cis s}(i)]−[p^{d}^{_{b}}(i−1)+p^{d}^{ᵤ}(i−1)+p^{d}^{ₛ}(i−1)−p^{c}^{_{b}}(i−1)−p^{c}^{ᵤ}(i−1)−p^{c}^{ₛ}(i−1)]≤p_{ESS}^{dev}(i)

If i=1,

[p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)]−[p_{ESS}^{dis,prev}−p_{ESS}^{chg,prev}]≤p_{ESS}^{dev}(i)

Here [p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)] is the ESS charge/discharge rate in the i-th time period. Also, [p^{d}^{_{b}}(i−1)+p^{d}^{ᵤ}(i−1)+p^{d}^{ₛ}(i−1)−p^{c}^{_{b}}(i−1)−p^{c}^{ᵤ}(i−1)−p^{c}^{ₛ}(i−1)] is the ESS charge/discharge rate in the i−1th time period. Therefore the given expression is a condition that (ESS charge/discharge rate in the i-th time period)−(ESS charge/discharge rate in the i−1th time period) has a value less than or equal to p_{ESS}^{dev}(i). When i=1, [p_{ESS}^{dis,prev}−p_{ESS}^{chg,prev}] is used instead of (ESS charge/discharge rate in the i−1th time period).

3) 0≤p_{ESS}^{dev}(i)

It is a condition that p_{ESS}^{dev}(i) has a value greater than or equal to zero.

$$4 ) {{\sum }_{i = 1}}^{N} {c}_{s m , E S S} \cdot dt \cdot {p}_{E S S}^{d e v} ( i ) \qquad$$

If this term is added to J, p_{ESS}^{dev}(i) which is a variable for smoothing the ESS charge/discharge rate is reflected in the objective function. To reduce the value of J, the value of p_{ESS}^{dev}(i) is reduced, so that the difference of ESS charge/discharge rate from the previous time period is reduced for each time period, thereby ESS charge/discharge rate smoothing is performed. If the value of C_{sm,ESS} is larger, the smoothing effect is reflected more.

### [Seventh Module]

1)) p^{c}^{_{b}}(i)+p^{c}^{ᵤ}(i)+p^{c}^{ₛ}(i) is the ESS charge rate, and p^{d}^{_{b}}(i)+p^{d}^{ᵤ}(i)+p^{d}^{ₛ}(i) is the ESS discharge rate, therefore p^{c}^{_{b}}(i)+p^{c}^{ᵤ}(i)+p^{c}^{ₛ}(i)−p^{d}^{_{b}}(i)−p^{d}^{ᵤ}(i)−p^{d}^{ₛ}(i) is the ESS charge/discharge rate. The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand

Therefore, NetDemand−ESS=Grid.

And the equation NetDemandMax−ESS=GridMax may be formulated when NetDemandMax is the maximum value of total demand, and GridMax is the maximum value of the grid power consumption, the following inequality can be formulated to express a condition that the maximum value of grid power consumption is less than the peak size.

$$- {p}^{{d}_{b}} ( i ) - {p}^{{d}_{u}} ( i ) - {p}^{{d}_{s}} ( i ) + {p}^{{c}_{b}} ( i ) + {p}^{{c}_{u}} ( i ) + {p}^{{c}_{s}} ( i ) + {\overline{p}}_{d , max} ( i ) \leq {p}_{P C}^{{g}_{b u y}} ( i ) + {p}_{PC}^{{g}_{b}^{peak}} ( i )$$

If the maximum value of the grid power consumption is large and the inequality does not hold with the set peak size, the condition is relaxed by increasing the relaxation variable p_{PC}^{g}^{_{buy}}(i).

$$2 ) {p}_{PC}^{{g}_{buy}} ( i ) \leq ( 1 - {δ}_{PC}^{{g}_{buy}} ( i ) ) ( {p}_{ESS}^{chg , max} ( i ) + {\overline{p}}_{d , max} ( i ) - {p}_{PC}^{{g}_{buy}^{peak}} ( i ) ) \\ i ) {p}_{PC}^{{g}_{buy}} ( i ) \leq ( 1 - 1 ) ( {p}_{ESS}^{chg , max} ( i ) + {\overline{p}}_{d , max} ( i ) - {p}_{PC}^{{g}_{buy}^{peak}} ( i ) )$$

$$if {δ}_{PC}^{{g}_{buy}} ( i ) = 1$$

(if the peak control is successful), therefore p_{PC}^{g}^{_{buy}}(i)≤0

$$ii ) {p}_{P C}^{{g}_{buy}} ( i ) + {p}_{PC}^{{g}_{buy}^{peak}} ( i ) \leq {p}_{E S S}^{chg , max} ( i ) + {\overline{p}}_{d , max} ( i ) \qquad$$

if δ_{PC}^{g}^{_{buy}}(i)=0 (if the peak control fails), therefore

$${p}_{PC}^{{g}_{buy}} ( i ) \leq {p}_{ESS}^{chg , max} ( i ) + {\overline{p}}_{d , max} ( i ) - {p}_{PC}^{{g}_{buy}^{peak}} ( i ) , \qquad$$

which is equivalent to

$${p}_{P C}^{{g}_{buy}} ( i ) + {p}_{PC}^{{g}_{buy}^{peak}} ( i ) \leq {p}_{E S S}^{chg , max} ( i ) + {\overline{p}}_{d , max} ( i ) \qquad$$

It is a condition that even if the peak size, which is the upper limit of the grid power consumption, and the value of the relaxation variable are added, it does not have to be greater than the sum of the ESS maximum charging rate and total demand.

3) 0≤p_{PC}^{g}^{_{buy}}(i)≤1

δ_{PC}^{g}^{_{buy}}(i) has a value between zero and 1, therefore 0 or 1 because it is an integer variable.

4) 0≤p_{PC}^{g}^{_{buy}}(i)

p_{PC}^{g}^{_{buy}}(i) has a nonnegative value.

$$5 ) {\sum }_{i ∈ {PC}_{g , buy}} [ - {c}_{PC , 1}^{{g}_{buy}} \{ 1 + {( {c}_{PC , 2}^{{g}_{buy}} )}^{i} \} dt \cdot {δ}_{PC}^{{g}_{buy}} ( i ) + {c}_{PC , 3}^{{g}_{buy}} dt \cdot {p}_{PC}^{{g}_{buy}} ( i ) ] \qquad$$

By adding this term to J, whether the peak control is successful will be reflected in the objective function. i∈P_{g,buy} means that the i-th time period is included in the time periods for performing peak control. If the peak control is successful, δ_{PC}^{g}^{_{buy}}(i)=1, therefore the value of j is decreased by the term −c_{PC,1}^{g}^{_{buy}}{1+(c_{PC,2}^{g}^{_{buy}})ⁱ}dt·1. If the value of c_{PC,1}^{g}^{_{buy}} is larger, the success of peak control is reflected more. If the peak control fails, δ_{PC}^{g}^{_{buy}}(i)=0, therefore −c_{PC,1}^{g}^{_{buy}}{1+(c_{PC,2}^{g}^{_{buy}})ⁱ}dt·0=0, and the value of J will not decrease. Since 0≤p_{PC}^{g}^{_{buy}}(i), the value of J increases by c_{PC,3}^{g}^{_{buy}}dt·p_{PC}^{g}^{_{buy}}(i). If c_{PC,3}^{g}^{_{buy}} is larger, then whether the peak control fails is reflected more.

### [Eighth Module]

1)

{p̅_{d,min}(i)+p_{ESS}^{chg,max}(i)}δ_{IO}^{g}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)≤p_{ESS}^{chg,max}(i)
i) The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand

Therefore, NetDemand−ESS=Grid.

When net zero operation is conducted, Grid=0. Therefore NetDemand−ESS=0. For NetDemand, NetDemandMin≤NetDemand holds, and applying NetDemand=ESS, the condition is expressed by the following inequality.

p̅_{d,min}(i)≤p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)

This is an inequality that can be obtained by applying δ_{IO}^{g}(i)=1 in the following inequality and is a condition for successful net zero energy operation.

{p̅_{d,min}(i)+p_{ESS}^{chg,max}(i)}δ_{IO}^{g}(i)−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)≤p_{ESS}^{chg,max}(i)
ii) If δ_{IO}^{g}(i)=0 (when net zero energy operation fails),

{p̅_{d,min}(i)+p_{ESS}^{chg,max}(i)}·0−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)≤p_{ESS}^{chg,max}(i)

Therefore,

−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i)≤p_{ESS}^{chg,max}(i)

p^{c}^{_{b}}(i)+p^{c}^{ᵤ}(i)+p^{c}^{ₛ}(i) is the Ess charge rate, and p^{d}^{_{b}}(i)−p^{dis u}(i)−p^{d}^{ₛ}(i) the ESS discharge rate, therefore p^{c}^{_{b}}(i)+p^{c}^{ᵤ}(i)+p^{c}^{ₛ}(i)−p^{d}^{_{b}}(i)−p^{d}^{ᵤ}(i)−p^{d}^{ₛ}(i) is the ESS charge/discharge rate, and the above inequality is a condition for the maximum Ess charge rate.

2)

−{p̅_{d,max}(i)−p_{ESS}^{dis,max}(i)}δ_{IO}^{g}(i)+p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)≤p_{ESS}^{dis,max}(i)
i) The condition that the power demand and power supply are balanced can be expressed by the following equation:

Load−PV−ESS−Grid=NetDemand−ESS−Grid=0

where Load=load
PV=electricity generated by the photovoltaic system
ESS=ESS charge/discharge rate
Grid=consumption of grid power
NetDemand=Total Demand

Therefore, NetDemand−ESS=Grid.

When net zero operation is conducted, Grid=0. Therefore NetDemand−ESS=0. For NetDemand, NetDemand≤NetDemandMax holds, and applying NetDemand=ESS, the condition is expressed by the following inequality.

p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)≤p̅_{d,max}(i)

This is an inequality that can be obtained by applying in the following inequality and is a condition for successful net zero energy operation.

−{p̅_{d,max}(i)−p_{ESS}^{dis,max}(i)}δ_{IO}^{g}(i)−p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)≤p_{ESS}^{dis,max}(i)
ii) δ_{IO}^{g}(i)=0 (when net zero energy operation fails),

−{p̅_{d,max}(i)−p_{ESS}^{dis,max}(i)}·0+p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)≤p_{ESS}^{dis,max}(i)

Therefore,

p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)≤p_{ESS}^{dis,max}(i)

p^{c}^{_{b}}(i)+p^{c}^{ᵤ}(i)+p^{c}^{ₛ}(i) is the Ess charge rate, and p^{d}^{_{b}}(i)+p^{d}^{ᵤ}(i)+p^{d}^{ₛ}(i) the ESS discharge rate, therefore p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i) is the ESS charge/discharge rate, and the above inequality is a condition for the maximum ESS discharge rate.

3) The condition that the ESS charge/discharge rate is less than or equal to the sum of the “minimum value of total demand” and the “relaxation variable when condition is not satisfied” is expressed by the following inequality.

p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)≤p̅_{d,min}(i)+p_{IO}^{g}(i)

4) The condition that the ESS charge/discharge rate is greater than or equal to the sum of the “maximum value of total demand” and the “relaxation variable when condition is not satisfied” is expressed by the following inequality.

p̅_{d,max}(i)−p_{IO}^{g}(i)−p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i)

5) 0≤δ_{IO}^{g}(i)≤1

δ_{IO}^{g}(i) has a value between zero and 1, and therefore 0 or 1 because it is an integer variable.

6) 0≤p_{IO}^{g}(i)

p_{IO}^{g}(i) has a nonnegative value.

$$7 ) {\sum }_{i ∈ {IO}_{g}} [ - {c}_{IO , 1}^{g} \{ 1 + {( {c}_{IO , 2}^{g} )}^{i} \} dt \cdot {δ}_{IO}^{g} ( i ) + {c}_{IO , 3}^{g} dt \cdot {p}_{IO}^{g} ( i ) ] \qquad$$

By adding this formula to J, whether the net zero energy operation is successful will be reflected in the objective function. i∈IO_{g} means that the i-th time period is included in the time periods for performing net zero energy operation. If the net zero energy operation is successful, δ_{IO}^{g}(i)=1, therefore the value of J is decreased by the term −c_{IO,1}^{g}{1+(c_{IO,2}^{g})ⁱ}dt·1. If the value of c_{IO,1}^{g} is larger, whether the operation is successful is reflected more. If the net zero energy operation fails, δ_{IO}^{g}(i)=0, therefore −c_{IO,1}^{g}{1+(c_{IO,2}^{g})ⁱ}dt·0=0, and the value of J will not decrease. Since 0≤p_{IO}^{g}(i), the value of J increases by c_{IO,3}^{g}dt·p_{IO}^{g}(i). If c_{IO,3}^{g} is larger, then whether the peak control fails is reflected more.

### [Ninth Module]

1) The condition that the ESS discharge amount must have a value greater than or equal to the set amount of demand response power is expressed by the following inequality.

Pₛₐᵥₑ−P_{DR}≤Σ{(p^{dis b}(i)+p^{dis u}(i)+p^{d}^{ₛ}(i)−p^{c}^{_{b}}(i)−p^{c}^{ᵤ}(i)−p^{c}^{ₛ}(i))dt}

If it is not satisfied, the condition is relaxed by increasing the value of the supplementary variable subtracted from the demand response power quantity.

2) P_{DR}≤(1−δ_{DR})[Pₛₐᵥₑ+Σ{p_{ESS}^{chg,max}(i)dt}]
i) If δ_{DR}−1 (when demand response is successful)

P_{DR}≤(1−1)[Pₛₐᵥₑ+Σ{p_{ESS}^{chg,max}(i)dt}]

Therefore, P_{DR}≤0
ii) If δ_{DR}=0 (when demand response fails)

P_{DR}≤(1−0)[Pₛₐᵥₑ+Σ{p_{ESS}^{chg,max}(i))dt}]

Therefore, Σ{−p_{ESS}^{chg,max}(i)dt}≤Pₛₐᵥₑ−P_{DR}
Utilizing the inequality above,

Σ{−p_{ESS}^{chg,max}(i)dt}≤Pₛₐᵥₑ−P_{DR}≤Σ{(p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i))dt}

### Therefore,

Σ{−p_{ESS}^{chg,max}(i)dt}≤Σ{(p^{d}^{_{b}}(i)+p^{d}^{ᵤ}(i)+p^{d}^{ₛ}(i)−p^{c}^{_{b}}(i)−p^{c}^{ᵤ}(i)−p^{c}^{ₛ}(i))dt}

Exchanging the terms, the condition for the ESS maximum charging rate is obtained as the following inequality.

{(−p^{d}^{_{b}}(i)−p^{d}^{ᵤ}(i)−p^{d}^{ₛ}(i)+p^{c}^{_{b}}(i)+p^{c}^{ᵤ}(i)+p^{c}^{ₛ}(i))dt}Σ{p_{ESS}^{chg,max}(i)dt}

3) 0≤δ_{DR}≤1

δ_{DR} has a value between zero and 1, and therefore 0 or 1 because it is an integer variable.

4) 0≤P_{DR}

P_{DR} has a nonnegative value.

5) For each DR,

−c_{DR,1}{1+(c_{DR,2})ⁱ}·δ_{DR}+c_{DR,3}·P_{DR}

By adding this formula to J, whether the demand response is successful will be reflected in the objective function. If the demand response is successful, δ_{DR}=1, therefore the value of J is decreased by the term −c_{DR,1}{1+(c_{DR,2})ⁱ}dt·1. If the value of c_{DR,1} is larger, whether it is successful is reflected more. If the demand response fails, δ_{DR}=0, therefore −c_{DR,1}{1+(c_{DR,2})ⁱ}dt·0=0, and the value of J will not decrease. Since 0≤P_{DR}, the value of J increases by c_{DR,3}·P_{DR}. If c_{DR,3} is larger, then whether it fails is reflected more.

### Example

Using the modules described above, tests were conducted as shown in tables 2-4.

TABLE 2

| | Time Period | | | | | | | | | | | |
|---|---|---|---|---|---|---|---|---|---|---|---|---|
| | 0~1 | 1~2 | 2~3 | 3~4 | 4~5 | 5~6 | 6~7 | 7~8 | 8~9 | 9~10 | 10~11 | 11~12 |
| Demand | 6.5 | 6.8 | 6.6 | 6.2 | 4.6 | 5 | 6.9 | 8.9 | 12.4 | 17.8 | 26.5 | 27.7 |

| | Time Period | | | | | | | | | | | |
|---|---|---|---|---|---|---|---|---|---|---|---|---|
| | 12~13 | 13~14 | 14~15 | 15~16 | 16~17 | 17~18 | 18~19 | 19~20 | 20~21 | 21~22 | 22~23 | 23~0 |
| Demand | 25.7 | 24 | 24.8 | 24.5 | 24.6 | 26.6 | 23.7 | 17.6 | 14.3 | 12.9 | 9.8 | 9.5 |

TABLE 3

| | Time Period | | | | | | | | | | | |
|---|---|---|---|---|---|---|---|---|---|---|---|---|
| | 0~1 | 1~2 | 2~3 | 3~4 | 4~5 | 5~6 | 6~7 | 7~8 | 8~9 | 9~10 | 10~11 | 11~12 |
| Supply | 0 | 0 | 0 | 0 | 0 | 0 | 0 | 3 | 6 | 9 | 15 | 15 |

| | Time Period | | | | | | | | | | | |
|---|---|---|---|---|---|---|---|---|---|---|---|---|
| | 12~13 | 13~14 | 14~15 | 15~16 | 16~17 | 17~18 | 18~19 | 19~20 | 20~21 | 21~22 | 22~23 | 23~0 |
| Supply | 15 | 18 | 12 | 12 | 6 | 3 | 0 | 0 | 0 | 0 | 0 | 0 |

TABLE 4

| | Time Period | | | | | | | | | | | |
|---|---|---|---|---|---|---|---|---|---|---|---|---|
| | 0~1 | 1~2 | 2~3 | 3~4 | 4~5 | 5~6 | 6~7 | 7~8 | 8~9 | 9~10 | 10~11 | 11~12 |
| Buying | 66.1 | 66.1 | 66.1 | 66.1 | 66.1 | 66.1 | 66.1 | 66.1 | 66.1 | 96.5 | 111.3 | 111.3 |
| Price Per | | | | | | | | | | | | |
| Unit | | | | | | | | | | | | |
| Selling | 66.1 | 66.1 | 66.1 | 66.1 | 66.1 | 66.1 | 66.1 | 66.1 | 66.1 | 96.5 | 111.3 | 111.3 |
| Price per | | | | | | | | | | | | |
| Unit | | | | | | | | | | | | |

| | Time Period | | | | | | | | | | | |
|---|---|---|---|---|---|---|---|---|---|---|---|---|
| | 12~13 | 13~14 | 14~15 | 15~16 | 16~17 | 17~18 | 18~19 | 19~20 | 20~21 | 21~22 | 22~23 | 23~0 |
| Buying | 96.5 | 96.5 | 96.5 | 96.5 | 96.5 | 111.3 | 111.3 | 111.3 | 96.5 | 96.5 | 111.3 | 66.1 |
| Price Per | | | | | | | | | | | | |
| Unit | | | | | | | | | | | | |
| Selling | 96.5 | 96.5 | 96.5 | 96.5 | 96.5 | 111.3 | 111.3 | 111.3 | 96.5 | 96.5 | 111.3 | 66.1 |
| Price per | | | | | | | | | | | | |
| Unit | | | | | | | | | | | | |

The settlement cost with the grid of the case when the EMS/ESS is not operated and that when the EMS/ESS is operated with the optimal operation schedule is shown in Table 5. Here no external conditions (peak control, net zero energy operation, demand response) were imposed

TABLE 5

| | Total Power Cost | Cost Saving by the |
|---|---|---|
| ESS | With the Operation | Operation of |
| Capacity | of EMS/ESS | EMS/ESS |
| 40 | 24370.8 | 215.5 |
| 50 | 24341.6 | 244.7 |
| 60 | 24313.0 | 273.3 |
| 70 | 24283.8 | 302.5 |
| 80 | 24255.3 | 331.0 |
| 90 | 24226.1 | 360.2 |
| 100 | 24197.6 | 388.7 |
| 110 | 24168.4 | 417.9 |
| 120 | 24139.8 | 446.5 |

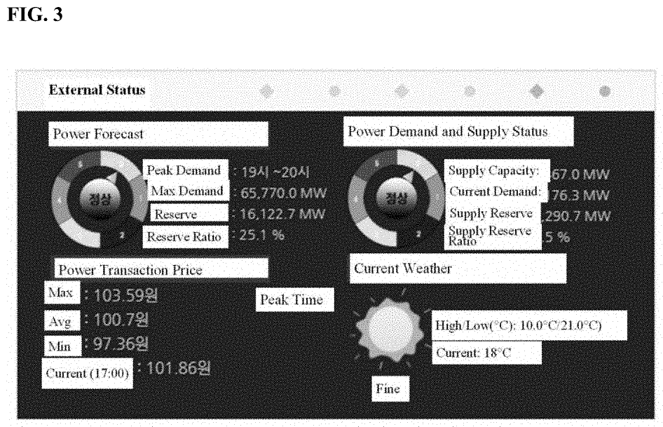

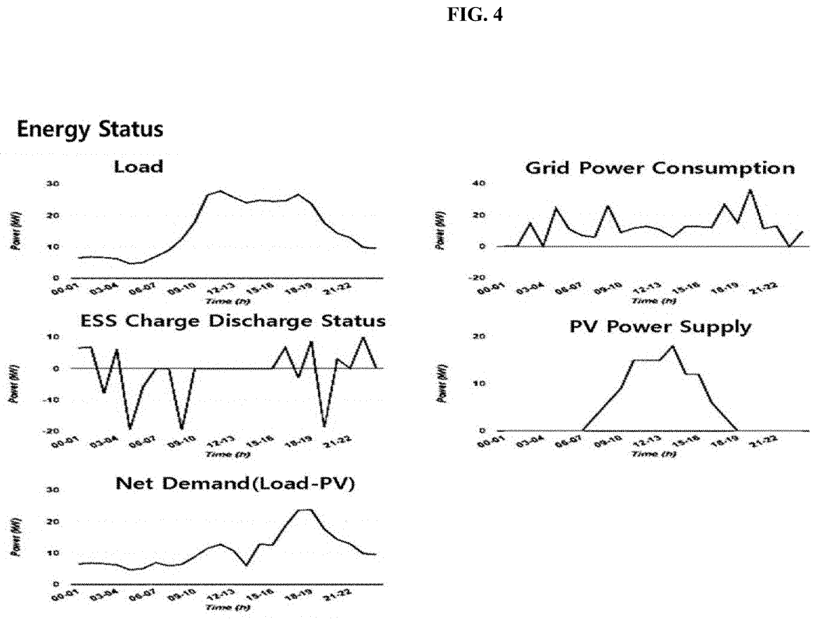

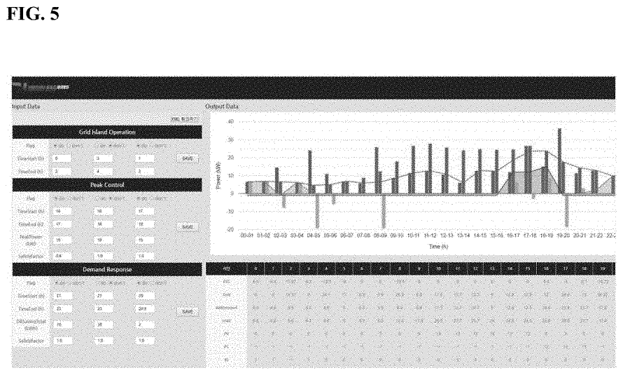

Table 3 shows forecasted values (kW) of the power demand schedule, Table 4 shows forecasted values (kW) of the power supply schedule, and Table 4 shows the forecasted value (won/kWh) of the power unit price schedule. These forecasts may be monitored or displayed (visualized) externally as shown in FIGS. 3 to 5. Here, the power forecast, power supply and demand status, power transaction price, current weather, etc. can be displayed, and the power forecast can include peak time forecast, maximum demand forecast, operational reserve, and operational reserve ratio. And the power supply and demand status may include supply capacity, current demand, supply reserve power, supply reserve ratio, etc., and the power transaction price may include maximum, average, minimum, current price, and the current weather may include lowest/highest and the current temperature.

While the embodiments of the present disclosure and their advantages have been described in detail, it should be understood that various changes, substitutions and alterations may be made herein without departing from the scope of the present disclosure.

What is claimed is:

1. A microgrid system comprising
an energy generation (EG) system;
one or more electrical load coupled to the EG system;
an ESS (energy storage system) coupled to the EG system and the electrical load;
an EMS (energy management system) for managing energy of the microgrid including the EG, the one or more electrical load, the ESS, and power transaction between the microgrid and a system power (grid);
wherein the EMS comprises:
a first module which forecasts power supply and demand, does operation scheduling, and controls ESS that stores EG electricity;
a second module for checking and managing state of charge of the ESS;
a third module for calculating and managing the discharge rate of the ESS;
a fourth module for system power flattening control to reduce a difference between maximum value and minimum value of system power by checking the load, the EG system generation amount, charge/discharge rate of the ESS, and the system power (grid) power usage by the microgrid;
a fifth module for system power smoothing control reducing a variation in the usage of system power by time periods;
a sixth module for controlling power smoothing of the ESS;
a seventh module for controlling the peak of power usage;
an eighth module for controlling net zero energy operation so that power demand and supply are balanced;
a ninth module for controlling a power demand response based on the amount of ESS discharge; and
a control unit for controlling each module,
wherein controlling operations of the modules are conducted so as to minimize the amount paid to the grid.

2. The microgrid system of claim 1 wherein the controlling operations of the modules are further conducted to reflect a difference between a maximum system power (grid) usage and a minimum system power (grid).

3. The microgrid system of claim 1 wherein the controlling operations of the modules are further conducted to reflect the peak power usage.

4. The microgrid system of claim 1 wherein the controlling operation of the modules are further conducted to reflect power smoothing of the ESS.

5. The microgrid system of claim 1 wherein the controlling operation of the modules are further conducted to reflect the net zero energy operation.

6. The microgrid system of claim 1 wherein the controlling operation of the modules are further conducted to reflect the power demand response based on the amount of ESS discharge.
